(19) United States
(12) Patent Application Publication
(10) Pub. No.: US 2011/0276921 A1
(43) Pub. Date: Nov. 10, 2011

(54) SELECTING CONTENT BASED ON INTEREST TAGS THAT ARE INCLUDED IN AN INTEREST CLOUD

(75) Inventor: James Andrew Long, Santa Clara, CA (US)

(73) Assignee: YAHOO! INC., Sunnyvale, CA (US)

(21) Appl. No.: 12/774,548

(22) Filed: May 5, 2010

(51) Int. Cl. G06F 3/048

(52) U.S. Cl. 715/825; 715/810; 715/862

(57) ABSTRACT

Techniques are described herein for selecting content based on interest tags that are included in an interest cloud. An interest cloud is a tag cloud that includes interest tags, which correspond to respective interests of a user. An interest of a user is subject matter that is deemed to have a greater importance than other subject matter to the user based on information that pertains to the user. For example, an interest of a user may be derived from information in the user's emails, vitality streams, Web browsing history, etc. In another example, a user may designate subject matter as being an interest of the user. For instance, if a user adds an interest tag to an interest cloud, subject matter that corresponds to the interest tag is said to be an interest of the user.

### BACKGROUND OF THE INVENTION

1. Field of the Invention

The present invention relates to techniques for selecting content to be provided to a user.

2. Background

In a computer networking environment (e.g., the Internet), users commonly access sites that are hosted by content providers, so that the users may receive content that is available via those sites. Users often have little control over which content they receive from content providers. For instance, some content providers provide the same content to every user who accesses their sites. Other content providers may allow users to enter keyword(s), which the content providers may use to determine which content to provide to the users. If a content provider is capable of providing content from other sources, the content provider may allow users to select the sources from which content is to be provided.

Techniques have been proposed to provide content that is more specifically tailored to users. For example, some content providers gather information regarding users each time the users visit sites that are hosted by the content providers. For instance, the content providers may categorize content that is available via their sites and then track which categories are accessed by the users, the frequency with which the users access those categories, etc. The content providers may use this information in an effort to determine which content is likely to interest the users. However, such techniques typical do not give users control over the content that they receive from content providers.

Thus, systems, methods, and computer program products are needed that address one or more of the aforementioned shortcomings of conventional techniques for selecting content to be provided to a user.

### BRIEF SUMMARY OF THE INVENTION

Various approaches are described herein for, among other things, selecting content based on interest tags that are included in an interest cloud. An interest cloud is a tag cloud that includes interest tags, which correspond to respective interests of a user. An interest of a user is subject matter that is deemed to have a greater importance than other subject matter to the user based on information that pertains to the user. For example, an interest of a user may be derived from information in the user's emails, vitality streams, Web browsing history, etc. In another example, a user may designate subject matter as being an interest of the user. For instance, if a user adds an interest tag to an interest cloud, subject matter that corresponds to the interest tag is said to be an interest of the user.

An example method is described for selecting content based on interest tags that are included in an interest cloud. In accordance with this example method, interests of a user are determined. An interest cloud that includes interest tags is provided. The interest tags correspond to the interests of the user. Content is selected to be provided to the user based on the interest tags.

An example system is also described. The example system includes an interest determination module, a cloud provider, and a content selector. The interest determination module is configured to determine interests of a user. The cloud provider is configured to provide an interest cloud that includes interest tags. The interest tags correspond to the interests of the user. The content selector is configured to select content to be provided to the user based on the interest tags.

An example computer program product is also described. The computer program product includes a computer-readable medium having computer program logic recorded thereon for selecting content to be provided to a user. The computer program logic includes first, second, and third program logic modules. The first program logic module is for enabling the processor-based system to determine interests of a user. The second program logic module is for enabling the processor-based system to provide an interest cloud that includes interest tags. The interest tags correspond to the interests of the user. The third program logic module is for enabling the processor-based system to select content to be provided to the user based on the interest tags.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example computer system in accordance with an embodiment described herein.

FIGS. 2 depicts a flowchart of an example method of selecting content based on interest tags that are included in an interest cloud in accordance with an embodiment described herein.

FIGS. 3 and 11-13 show example interest clouds in accordance with embodiments described herein.

FIG. 4 depicts a flowchart of an example method of providing an interest cloud in accordance with an embodiment described herein.

FIG. 5 depicts a flowchart of an example method of changing a priority attribute of an interest tag in accordance with an embodiment described herein.

FIG. 6 depicts a flowchart of an example method of enabling a user to change a content attribute of an interest tag in accordance with an embodiment described herein.

FIG. 7 depicts a flowchart of an example method of selecting content based on content attributes of interest tags in accordance with an embodiment described herein.

FIG. 8 depicts a flowchart of an example method of adding an interest tag to an interest could in accordance with an embodiment described herein.

FIG. 9 depicts a flowchart of an example method of updating content that is provided to a user in accordance with an embodiment described herein.

FIGS. 10 and 17 are block diagrams of example implementations of an interest cloud module shown in FIG. 1 in accordance with embodiments described herein.

FIG. 14 depicts a flowchart of an example method of adding a cumulative interest tag to an interest cloud in accordance with an embodiment described herein.

FIG. 15 depicts a flowchart of an example method of recommending an interest tag to a user in accordance with an embodiment described herein.

FIG. 16 depicts a flowchart of an example method of providing access to an interest cloud in accordance with an embodiment described herein.

FIG. 18 shows example content that may be provided to a user in accordance with an embodiment described herein.

FIG. 19 is a block diagram of a computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Example embodiments are capable of selecting content based on interest tags that are included in an interest cloud. An interest cloud is a tag cloud that includes interest tags, which correspond to respective interests of a user. An interest of a user is subject matter that is deemed to have a greater importance than other subject matter to the user based on information that pertains to the user. For example, an interest of a user may be derived from information in the user's emails, vitality streams, Web browsing history, etc. In another example, a user may designate subject matter as being an interest of the user. For instance, if a user adds an interest tag to an interest cloud, subject matter that corresponds to the interest tag is said to be an interest of the user. An interest of a user is distinguishable from subject matter that is defined by keywords derived from Web search results, for example, because such keywords are not based on information that pertains to the user. Rather, the keywords are based merely on their occurrence in the Web search results.

Techniques described herein for selecting content based on interest tags that are included in an interest cloud have a variety of benefits as compared to conventional techniques for selecting content. For example, the techniques described herein may give users control over the content that they receive from content providers. For example, users may add, delete, and/or modify interest tags in an interest cloud. Users may prioritize the interest tags and/or change priorities that are associated with the interest tags. Users may map each interest tag to a respective type of content (e.g., image, news, video, etc.). Each interest tag may indicate a source from which the interest tag is provided. Content may be updated in real-time when a change is made to an interest tag upon which the content is based. Users may create relationships between interest tags to create cumulative interest tags. A relationship between interest tags may be based on a Boolean operator. Some examples of a Boolean operator include but are not limited to AND, OR, NAND, NOR, etc. Example embodiments are capable of recommending interest tags and/or relationships between interest tags to a user.

### II. Example Embodiments

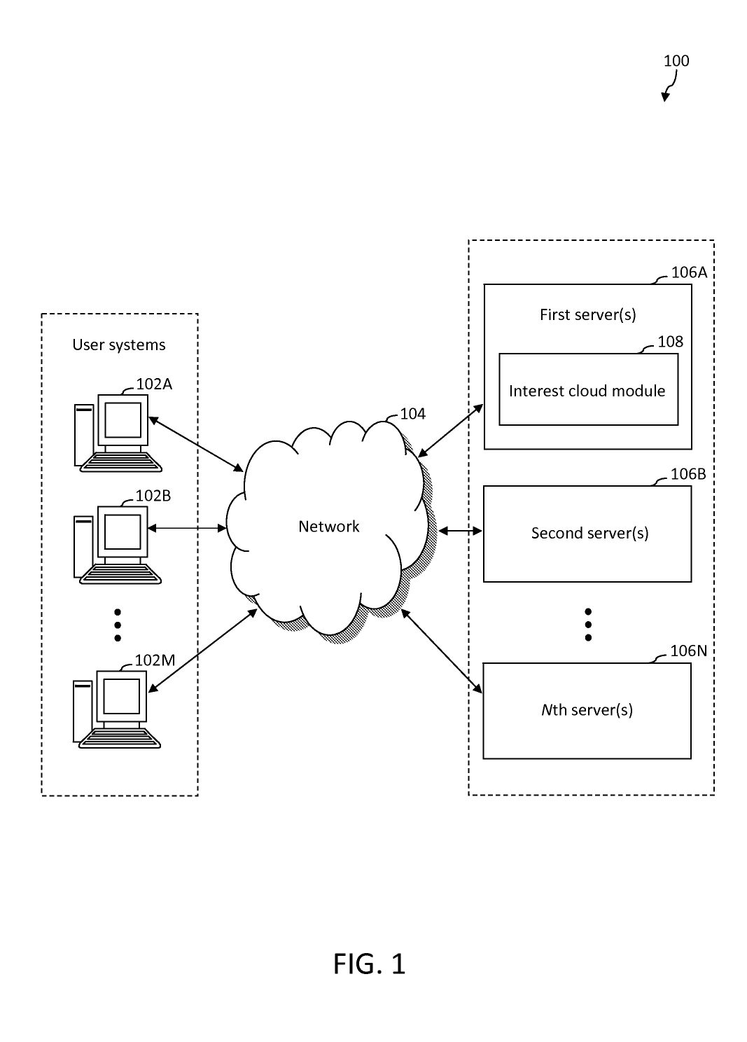

FIG. 1 is a block diagram of an example computer system 100 in accordance with an embodiment described herein. Generally speaking, computer system 100 operates to provide content to users in response to requests (e.g., hypertext transfer protocol (HTTP) requests) that are provided by the users. The content may include Web pages, images, videos, other types of files, output of executables, etc. and/or links thereto. In accordance with example embodiments, computer system 100 is configured to select content to be provided to the users based on interest tags that are included in respective interest clouds.

As shown in FIG. 1, computer system 100 includes a plurality of user systems 102A-102M, a network 104, and a plurality of servers 106A-106N. Communication among user systems 102A-102M and servers 106A-106N is carried out over network 104 using well-known network communication protocols. Network 104 may be a wide-area network (e.g., the Internet), a local area network (LAN), another type of network, or a combination thereof.

User systems 102A-102M are computers or other processing systems, each including one or more processors, that are capable of communicating with servers 106A-106N. User systems 102A-102M are capable of accessing sites (e.g., Web sites) hosted by servers 104A-104N, so that user systems 102A-102M may access content that is available via the sites. User systems 102A-102M are configured to provide requests (e.g., hypertext transfer protocol (HTTP) requests) to servers 106A-106N for requesting content stored on (or otherwise accessible via) servers 106A-106N. For instance, a user may initiate a request for content using a client (e.g., a Web crawler, a Web browser, a non-Web-enabled client, etc.) deployed on a user system 102 that is owned by or otherwise accessible to the user.

Servers 106A-106N are computers or other processing systems, each including one or more processors, that are capable of communicating with user systems 102A-102M. Servers 106A-106N are configured to host respective sites (e.g., Web sites), so that the sites are accessible to users of computer system 100. Servers 106A-106N are further configured to provide content to users in response to receiving requests (e.g., HTTP requests) from the users.

First server(s) 106A includes an interest cloud module 108. Interest cloud module 108 is configured to determine interests of users who access first server(s) 106A. Any suitable technique or combination of techniques may be used to determine the interests of the users. For example, interest cloud module 108 may determine interests of a user based on interest indicators that are received from the user via a respective user system 102. In accordance with this example, the interest indicators specify the interests of the user. In another example, interest cloud module 108 may review (e.g., mine) information regarding a user to determine interests of the user. For instance the information may be stored on first server(s) 106A, on a user system 102 of the user, and/or elsewhere. Such information may include email messages, vitality streams, Web browsing history, and/or other information regarding the user.

Interest cloud module 108 is further configured to provide an interest cloud for each user. Interest cloud module 108 is capable of populating the interest cloud of each user with interest tags that correspond to interests of the user. The interest clouds may be interactive, such that the users are allowed to edit their interest clouds. For instance, interest cloud module 108 may add interest tags to a user's interest cloud, delete interest tags from the user's interest cloud, and/or modify interest tags that are included in the user's interest cloud based on instructions received from a user system 102 that is owned by or otherwise accessible to the user.

Interest cloud module 108 is further configured to select content to be provided to the users based on the interest tags that are included in the interest clouds of the respective users. For instance, interest cloud module 108 may provide first content to a first user based on the first user's interest tags; interest cloud module 108 may provide second content to a second user based on the second user's interest tags, and so on. Further detail regarding techniques for selecting content based on interest tags that are included in an interest cloud is provided in the following discussion.

First server(s) 106A is shown to include interest cloud module 108 for illustrative purposes. It will be recognized that any one or more of servers 106A-106N may include an interest cloud module, such as interest cloud module 108. It will be further recognized that any one or more user systems 102A-102M may communicate with any one or more servers 106A-106N. Although user systems 102A-102M are depicted as desktop computers in FIG. 1, persons skilled in the relevant art(s) will appreciate that user systems 102A-102M may include any client-enabled system or device, including but not limited to a laptop computer, a tablet computer, a personal digital assistant, a cellular telephone, etc. It will be recognized that although some operations are described herein as being performed by a user for ease of discussion, such operations may be performed by a respective user system 102 or by interest cloud module 108 in response to an instruction that is received from the user.

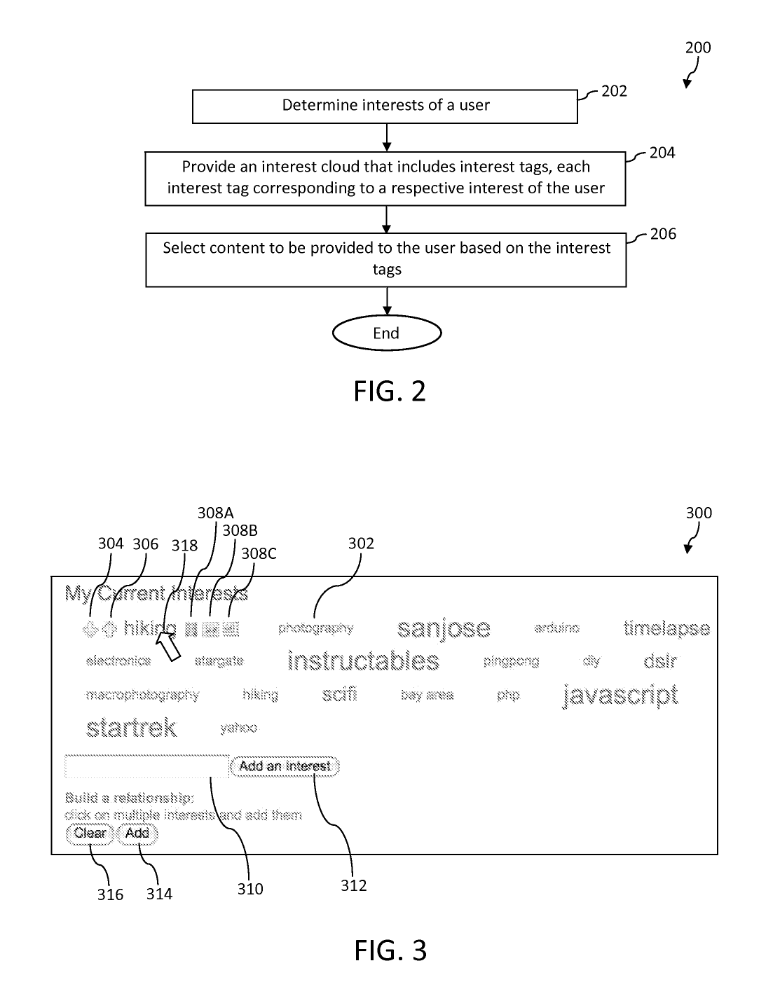

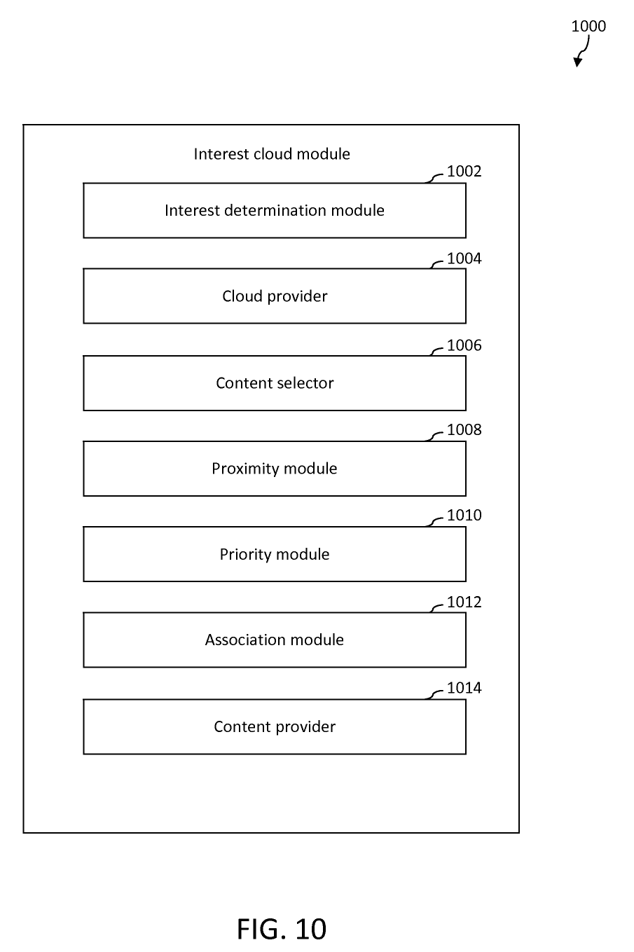

FIGS. 2, 4-9, and 14 depict flowcharts 200, 400, 500, 600, 700, 800, 900, and 1400 of example methods in accordance with embodiments described herein. Flowcharts 200, 400, 500, 600, 700, 800, 900, and 1400 may be performed by interest cloud module 108 of computer system 100 shown in FIG. 1, for example. For illustrative purposes, flowcharts 200, 400, 500, 600, 700, 800, 900, and 1400 are described with respect to an interest cloud module 1000 shown in FIG. 10, which is an example of an interest cloud module 108, according to an embodiment. As shown in FIG. 10, interest cloud module 1000 includes an interest determination module 1002, a cloud provider 1004, a content selector 1006, a proximity module 1008, a priority module 1010, an association module 1012, a content provider 1014, and a recommendation module 1016. Further structural and operational embodiments will be apparent to persons skilled in the relevant art(s) based on the discussion regarding flowcharts 200, 400, 500, 600, 700, 800, 900, and 1400.

FIGS. 2 depicts a flowchart 200 of an example method of selecting content based on interest tags that are included in an interest cloud in accordance with an embodiment described herein. As shown in FIG. 2, the method of flowchart 200 begins at step 202. In step 202, interests of a user are determined In an example implementation, interest determination module 1002 determines the interests of the user. For example, interest determination module 1002 may interpret indicators that are received from the user to determine the interests of the user. In accordance with this example, the indicators specify the interests of the user. In an aspect, the interests that are specified by the indicators may be based on interest tags that are included in another user's interest cloud. For instance, the indicators may specify interest tags that are selected by the user from the other user's interest cloud. In another example, interest determination module 1002 may review information regarding the user to determine the interests of the user. The information may include any suitable type of information, such as email messages sent or received by the user, vitality streams of the user, Web browsing history of the user, etc.

At step 204, an interest cloud that includes interest tags is provided. Each interest tag corresponds to a respective interest of the user. The interest cloud may be interactive to enable the user to add interest tag(s) to the interest cloud, delete interest tag(s) from the interest cloud, and/or modify interest tag(s) that are included in the interest cloud, though the scope of the example embodiments is not limited in this respect. Modifying an interest tag may include changing a priority of the interest tag, changing a type of content that is associated with the interest tag, etc. In an example implementation, cloud provider 1004 provides the interest cloud.

At step 206, content is selected to be provided to the user based on the interest tags. The content may be aggregated content, though the scope of the example embodiments is not limited in this respect. Aggregated content is content that is combined from multiple sources. In an example implementation, content selector 1006 selects the content to be provided to the user.

In some example embodiments, the content is selected based on priorities of the respective interest tags. The priority of an interest tag corresponds to a degree with which the interest tag is taken into consideration for purposes of selecting content to be provided to the user. For example, an interest tag that has a relatively high priority may have a greater effect on which content is selected than another interest tag that has a relatively low priority. In one such embodiment, if the interest tags have priorities that range from a lowest priority to a highest priority, interest tags that have the highest priority may be matched against content that is available to be provided to the user. A first subset of the content that matches the highest priority interest tag(s) may be selected to be provided to the user. If more content is desired, interest tag(s) that have a next highest priority may be matched against the content that is available. A second subset of the content that matches the next highest priority interest tags may be selected to be provided to the user in addition to the first subset. For instance, the second subset may be filtered, such that the second subset does not include content that is included in the first subset. Content may continue to be selected in this manner until a threshold amount of content has been selected, for example. In one aspect, an amount of content that is selected for each of one or more of the priorities may be limited to a respective threshold amount.

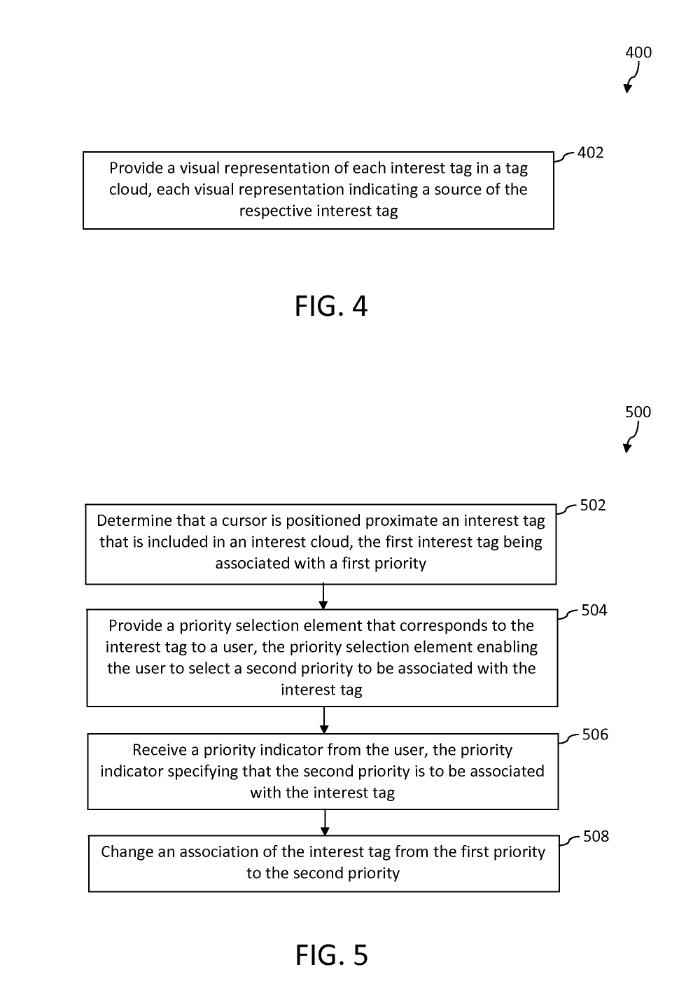

Other elements of interest cloud module 1000 are discussed below with reference to FIGS. 4-9 and 14. It will be recognized that interest cloud module 1000 may not include one or more of interest determination module 1002, cloud provider 1004, content selector 1006, proximity module 1008, priority module 1010, association module 1012, content provider 1014, and/or recommendation module 1016. Furthermore, interest cloud module 1000 may include modules in addition to or in lieu of interest determination module 1002, cloud provider 1004, content selector 1006, proximity module 1008, priority module 1010, association module 1012, content provider 1014, and/or recommendation module 1016.

FIG. 3 shows an example interest cloud 300 in accordance with an embodiment described herein. For instance, interest cloud 300 may be provided to a user via a browser that is installed on a user system (e.g., any of user systems 102A-102M). As shown in FIG. 3, interest cloud 300 includes a plurality of interest tags 302. The interest tags 302 are respectively labeled as “hiking”, “photography”, “sanjose”, and so on. Each interest tag may be associated with one or more attributes. Examples of attributes include but are not limited to a priority of an interest tag, a type of content that is associated with the interest tag, a source of the interest tag, whether the interest tag is flagged for publication to other users, etc.

In FIG. 3, a cursor 318 is positioned proximate the “hiking” interest tag for illustrative purposes, causing indicators 304, 306, and 308A-308C to appear. Each of indicators 304, 306, and 308A-308C is associated with a respective attribute of the “hiking” interest tag. For instance, indicators 304 and 306 are associated with a priority attribute of the “hiking” interest tag. Accordingly, indicators 304 and 306 are referred to as priority indicators. Priority indicators 304 and 306 may be used to change a priority that is associated with the “hiking” interest tag. Priority indicator 304 is shown as an upward arrow for illustrative purposes. A user may select (e.g., click on) priority indicator 304 to increase the priority of the “hiking” interest tag. Priority indicator 306 is shown as a downward arrow for illustrative purposes. The user may select priority indicator 306 to decrease the priority of the “hiking” interest tag.

Indicators 308A-308C are associated a content attribute of the “hiking” interest tag. Accordingly, indicators 308A-308C are referred to as content indicators. Content indicators 308A-308C may be used to associate the “hiking” interest tag with designated types of content. Content indicators 308A-308C correspond to video content, image content, and news content, respectively. The “hiking” interest tag is shown to be associated with three types of content—video content, image content, and news content—for illustrative purposes and is not intended to be limiting. For example, the “hiking” interest tag may not be associated with one or more of video content, image content, and/or news content. In another example, the “hiking” interest tag may be associated with other type(s) of content in lieu of or in addition to video content, image content, and/or news content.

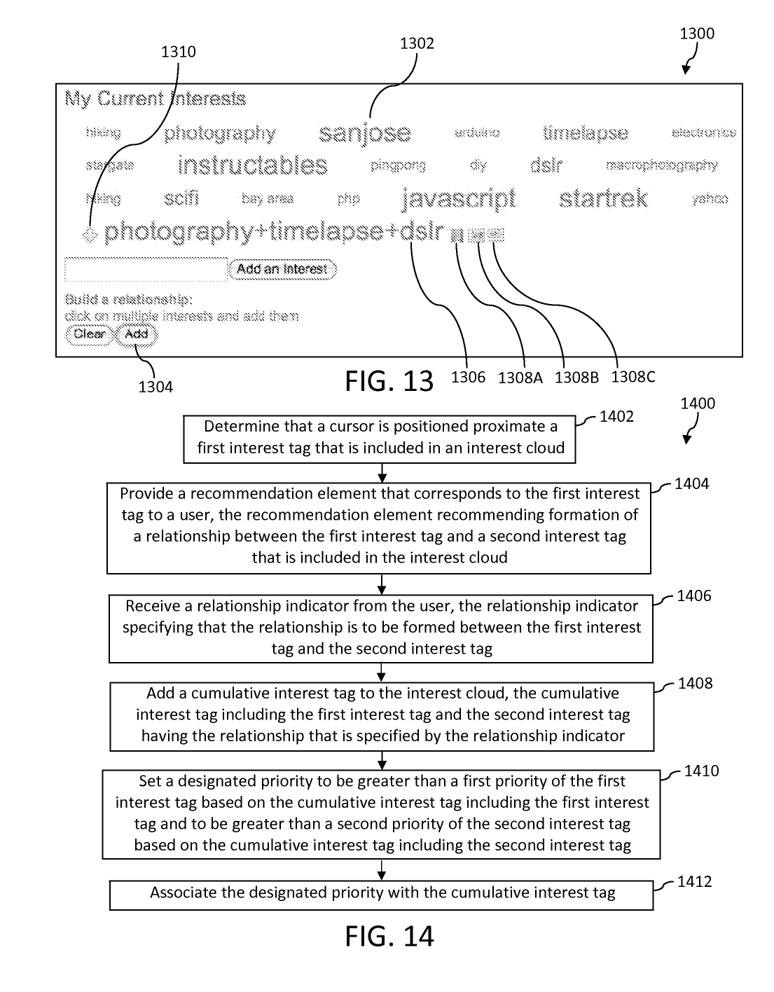

A user may type an interest into window 310 and select add button 312 to add an interest tag that corresponds to the interest to the interest cloud 300. Add button 314 and clear button 316 may be used for creating a cumulative interest tag that includes two or more of the interest tags 302. Further description of the functionality associated with buttons 314 and 316 is provided below with reference to FIGS. 12 and 13.

A user may delete an interest tag from interest cloud 300 in any of a variety of ways. For example, the user may “right-click” the interest tag to access a drop-down, pop-up, or equivalent menu, or other graphical interface element from which the user may select a “delete” indicator. In another example, the user may place cursor 318 proximate a designated portion (e.g., right side, left side, top, bottom, etc.) of the interest tag to cause a “delete” indicator to be displayed. In either example, the user may select the “delete” indicator to initiate deletion of the interest tag from the interest cloud 300.

In FIG. 3, cursor 318 is shown to overlap the “hiking” interest tag. It will be recognized, however, that cursor 318 need not necessarily overlap a tag in order for cursor 318 to be positioned proximate the tag. Moreover, priority indicators 304 and 306 and content indicators 308A-308C are shown in FIG. 3 for illustrative purposes and are not intended to be limiting. It will be recognized that any suitable types of indicators, corresponding to any suitable attributes, may be provided with respect to an interest tag to enable a user to control values of those attributes.

It will be recognized that a user need not necessarily position a cursor proximate an interest tag in order for attributes of the interest tag to be determined For example, the interest tag may be configured to indicate one or more of its attributes without the need for an action by the user. For instance, FIG. 4 depicts a flowchart 400 of an example method of providing an interest cloud in accordance with an embodiment described herein. As shown in FIG. 4, the method of flowchart 400 includes step 402. At step 402, a visual representation of each interest tag in the interest cloud is provided. Each visual representation indicates a source of the respective interest tag. For example, each visual representation may be associated with a respective color to indicate the source of the respective interest tag. In accordance with this example, each source may correspond to a different color. In another example, each visual representation may be associated with a respective icon (or type of icon). In accordance with this example, each source may correspond to a different icon or type thereof. A source is one example attribute that an interest tag may have. It will be recognized that each visual representations may indicate any suitable attribute(s) in addition to or in lieu of the source of the respective interest tag. In an example implementation, cloud provider 1004 provides the visual representation of each interest tag.

FIG. 5 depicts a flowchart 500 of an example method of changing a priority attribute of an interest tag in accordance with an embodiment described herein. As shown in FIG. 5, the method of flowchart 500 begins at step 502. In step 502, a determination is made that a cursor is positioned proximate an interest tag that is included in an interest cloud. The interest tag is associated with a first priority. In an example implementation, proximity module 1008 determines that the cursor is positioned proximate the interest tag. In some example embodiments, step 502 need not necessarily be performed.

At step 504, a priority selection element that corresponds to the interest tag is provided to a user. The priority selection element enables the user to select a second priority to be associated with the interest tag. In an example implementation, priority module 1010 provides the priority selection element that corresponds to the interest tag to the user.

At step 506, a priority indicator is received from the user. The priority indicator specifies that the second priority is to be associated with the interest tag. In an example implementation, association module 1012 receives the priority indicator from the user.

At step 508, an association of the interest tag is changed from the first priority to the second priority. Accordingly, it may be said that a priority attribute of the interest tag is changed to indicate that the interest tag is associated with the second priority. In an example implementation, association module 1012 changes the association of the interest tag from the first priority to the second priority.

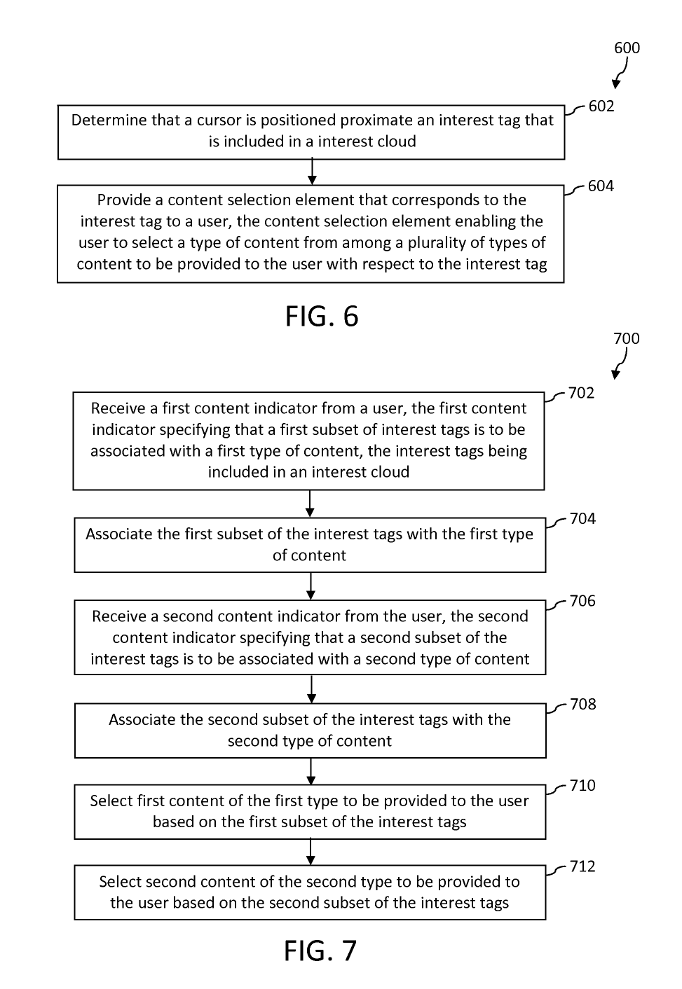

FIG. 6 depicts a flowchart 600 of an example method of enabling a user to change a content attribute of an interest tag in accordance with an embodiment described herein. As shown in FIG. 6, the method of flowchart 600 begins at step 602. In step 602, a determination is made that a cursor is positioned proximate an interest tag that is included in an interest cloud. In an example implementation, proximity module 1008 determines that the cursor is positioned proximate the interest tag. In some example embodiments, step 602 need not necessarily be performed.

At step 604, a content selection element that corresponds to the interest tag is provided to a user. The content selection element enables the user to select a type of content from among a plurality of types of content to be provided to the user with respect to the interest tag. In an example implementation, content selector 1006 provides the content selection element that corresponds to the interest tag to the user.

FIG. 7 depicts a flowchart 700 of an example method of selecting content based on content attributes of interest tags in accordance with an embodiment described herein. As shown in FIG. 7, the method of flowchart 700 begins at step 702. In step 702, a first content indicator is received from the user. The first content indicator specifies that a first subset of interest tags is to be associated with a first type of content. The interest tags are included in an interest cloud. In an example implementation, association module 1012 receives the first content indicator from the user.

At step 704, the first subset of the interest tags is associated with the first type of content. Accordingly, it may be said that a content attribute of each tag in the first subset is set to specify the first type of content. In an example implementation, association module 1012 associates the first subset of the interest tags with the first type of content.

At step 706, a second content indicator is received from the user. The second content indicator specifies that a second subset of the interest tags is to be associated with a second type of content. In an example implementation, association module 1012 receives the second content indicator from the user.

At step 708, the second subset of the interest tags is associated with the second type of content. Accordingly, it may be said that a content attribute of each tag in the second subset is set to specify the second type of content. In an example implementation, association module 1012 associates the second subset of the interest tags with the second type of content.

At step 710, first content of the first type is selected to be provided to the user based on the first subset of the interest tags. In an example implementation, content selector 1006 selects the first content of the first type to be provided to the user based on the first subset of the interest tags.

At step 712, second content of the second type is selected to be provided to the user based on the second subset of the interest tags. In an example implementation, content selector 1006 selects the second content of the second type to be provided to the user based on the second subset of the interest tags.

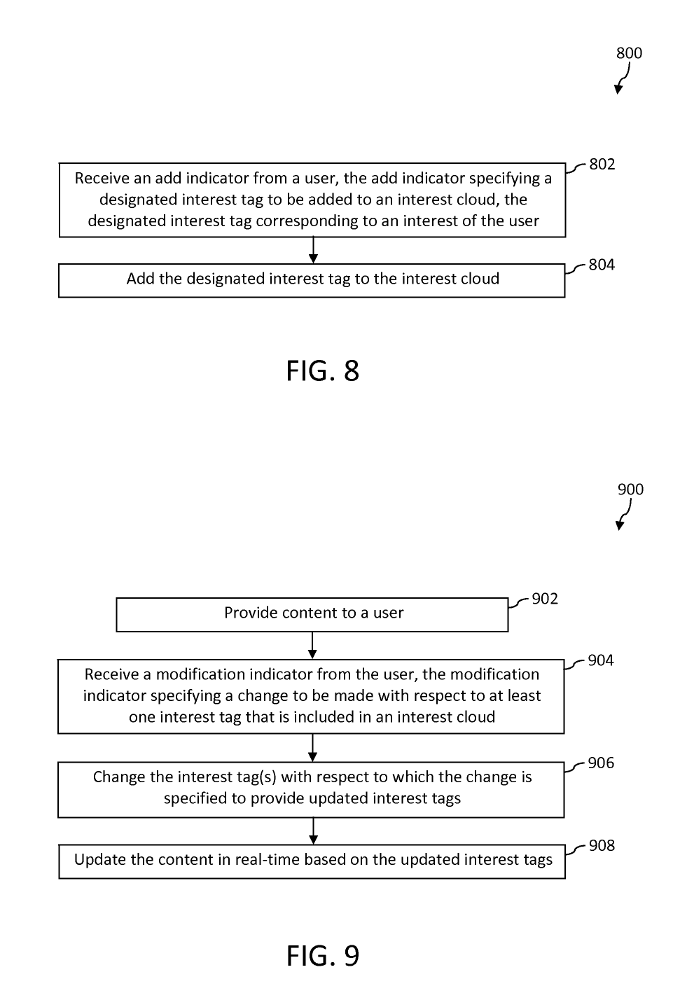

FIG. 8 depicts a flowchart 800 of an example method of adding an interest tag to an interest could in accordance with an embodiment described herein. As shown in FIG. 8, the method of flowchart 800 begins at step 802. In step 802, an add indicator is received from a user. The add indicator specifies a designated interest tag to be added to an interest cloud. The designated interest tag corresponds to an interest of the user. In an example implementation, cloud provider 1004 receives the add indicator from the user.

At step 804, the designated interest tag is added to the interest cloud. In an example implementation, cloud provider 1004 adds the designated interest tag to the interest cloud.

FIG. 9 depicts a flowchart 900 of an example method of updating content that is provided to a user in accordance with an embodiment described herein. As shown in FIG. 9, the method of flowchart 900 begins at step 902. In step 902, content is provided to a user. In an example implementation, content provider 1014 provides the content to the user.

At step 904, a modification indicator is received from the user. The modification indicator specifies a change to be made with respect to at least one interest tag that is included in an interest cloud. In an example implementation, cloud provider 1004 receives the modification indicator from the user.

At step 906, the interest tag(s) with respect to which the change is specified are changed to provide updated interest tags. In an example implementation, cloud provider 1004 changes the interest tag(s) with respect to which the change is specified.

At step 908, the content is updated in real-time based on the updated interest tags. In an example implementation, content provider 1014 updates the content in real-time based on the updated interest tags.

In an example embodiment, as the content is updated in real-time at step 908, a cron job is run as a background process to aggregate more relevant content, which is not available for provision to the user in real-time. In another example embodiment, the cron job is run and the more relevant content is provided to the user in lieu of performing step 908.

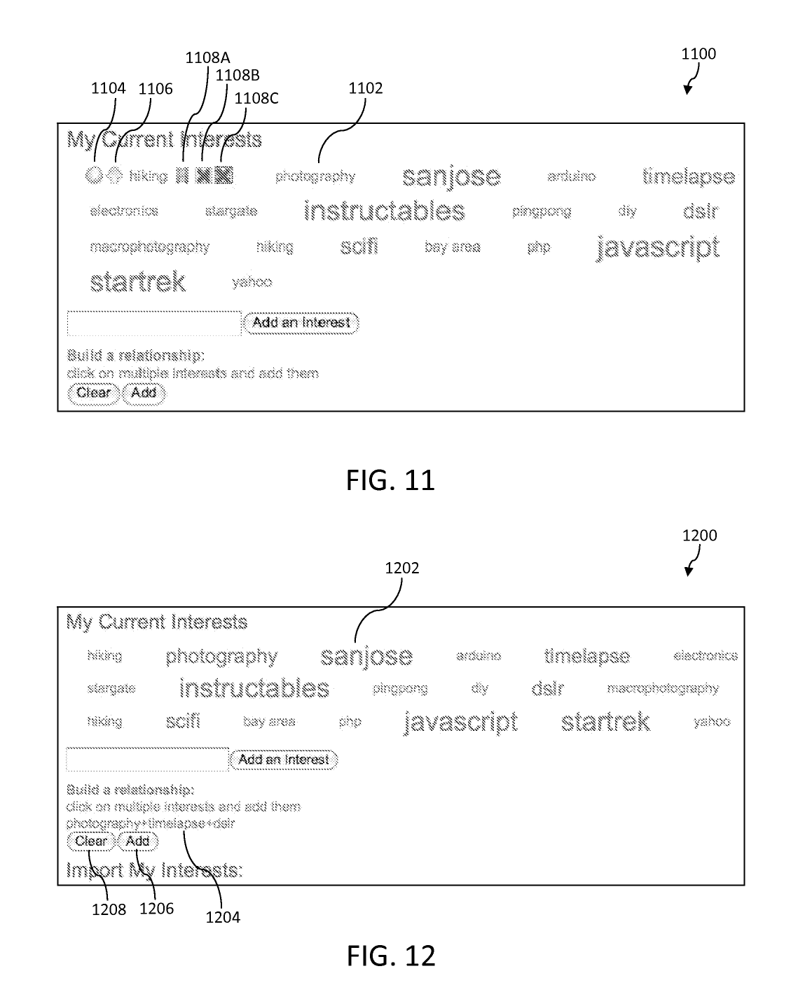

FIGS. 11-13 show other example interest clouds 1100, 1200, and 1300 in accordance with embodiments described herein. As shown in FIG. 11, interest cloud 1100 includes a plurality of interest tags 1102, one of which is labeled as “hiking”. The “hiking” interest tag is associated with priority indicators 1104 and 1106 and content indicators 1108A-1108C. Priority indicator 1104 is used for decreasing a priority of the “hiking” interest tag. Priority indicator 1106 is used for increasing the priority of the “hiking” interest tag. Priority indicator 1104 is shown as a circle that includes an “X”, indicating that the priority of the “hiking” interest tag cannot be decreased. For instance, the priority that is associated with the “hiking” interest tag in FIG. 11 may be the lowest priority in a range of priorities from which the user may select.

A font size of an interest tag may correspond to a priority of the interest tag. For instance, an interest tag having a relatively high priority may have a relatively large font; whereas, an interest tag having a relatively low priority may have a relatively small font. As shown in FIG. 11, the “hiking” interest tag has the smallest font size of those shown with respect to the interest tags 1102 in FIG. 11 to reflect that the “hiking” interest tag has the lowest priority.

Content indicators 1108A-1108C correspond to video content, image content, and news content, respectively. Content indicator 1108A specifies that the “hiking” interest tag is associated with video content, meaning that the “hiking” interest tag is to be taken into consideration for purposes of providing video content to the user. Content indicator 1108B is shown to include an “X”, indicating that the “hiking” interest tag is not associated with image content. Content indicator 1108C is also shown to include an “X”, indicating that the “hiking” interest tag is not associated with news content. Accordingly, the “hiking” interest tag is not to be taken into consideration for purposes of providing image content or news content to the user.

As shown in FIG. 12, interest cloud 1200 includes a plurality of interest tags 1202. A user may select two or more of the interest tags 1202 for creation of a cumulative interest tag that includes the selected interest tags. For example, text 1204 indicates that the user has selected “photography”, “timelapse”, and “dslr” interest tags. The user may select add button 1202 to add the cumulative interest tag of “photography+timelapse+dslr” to interest cloud 1206. Alternatively, the user may select clear button 1208 to erase text 1204. Upon erasing text 1204, the user may again select two or more of the interest tags 1202 for creation of a cumulative interest tag that includes the selected interest tags.

As shown in FIG. 13, interest cloud 1300 includes a plurality of interest tags 1302. The plurality of interest tags 1302 includes a cumulative interest tag 1306 that is a combination of the “photography”, “timelapse”, and “dslr” interest tags. For example, a user may select the “photography”, “timelapse”, and “dslr” interest tags and then select add button 1304 to add the “photography+timelapse+dslr” cumulative interest tag 1306 to interest cloud 1300. Cumulative interest tag 1306 is associated with a priority indicator 1310 and content indicators 1308A-1308C. Priority indicator 1310 may be selected by the user to decrease a priority of cumulative interest tag 1306. FIG. 13 does not show a priority indicator for increasing the priority of cumulative interest tag 1306. For example, the priority of cumulative interest tag 1306 may be the highest priority in a range of priorities from which the user may select. In accordance with this example, there is no need for a priority indicator that enables the user to increase the priority of cumulative interest tag 1306 unless the priority of cumulative interest tag 1306 is decreased to a priority that is less than the highest priority. Cumulative interest tag 1306 is shown to have the largest font size of those shown with respect to the interest tags 1302 in FIG. 13 to reflect that cumulative interest tag is associated with the highest priority.

FIG. 14 depicts a flowchart 1400 of an example method of adding a cumulative interest tag to an interest cloud in accordance with an embodiment described herein. As shown in FIG. 14, the method of flowchart 1400 begins at step 1402. In step 1402, a determination is made that a cursor is positioned proximate a first interest tag that is included in an interest cloud. In an example implementation, proximity module 1008 determines that the cursor is positioned proximate the first interest tag.

At step 1404, a recommendation element that corresponds to the first interest tag is provided to a user. The recommendation element recommends formation of a relationship between the first interest tag and a second interest tag that is included in the interest cloud. For example, the recommendation element may recommend that the first interest tag and the second interest tag be combined using a Boolean operator (e.g., an AND operator, an OR operator, etc.). In an example implementation, recommendation module 1016 provides the recommendation that corresponds to the first interest tag to the user.

At step 1406, a relationship indicator is received from the user. The relationship indicator specifies that the relationship is to be formed between the first interest tag and the second interest tag. In an example implementation, cloud provider 1014 receives the relationship indicator from the user.

At step 1408, a cumulative interest tag is added to the interest cloud. The cumulative interest tag includes the first interest tag and the second interest tag having the relationship that is specified by the relationship indicator. In an example implementation, cloud provider 1014 adds the cumulative interest tag to the interest cloud.

At step 1410, a designated priority is set to be greater than a first priority of the first interest tag based on the cumulative interest tag including the first interest tag and to be greater than a second priority of the second interest tag based on the cumulative interest tag including the second interest tag. In an example implementation, association module 1012 sets the designated priority to be greater than the first priority of the first interest tag and to be greater than the second priority of the second interest tag.

At step 1412, the designated priority is associated with the cumulative interest tag. In an example implementation, association module 1012 associates the designated priority with the cumulative interest tag.

In some example embodiments, one or more steps 1402, 1404, 1406, 1408, 1410, and/or 1412 of flowchart 1400 may not be performed. Moreover, steps in addition to or in lieu of steps 1402, 1404, 1406, 1408, 1410, and/or 1412 may be performed.

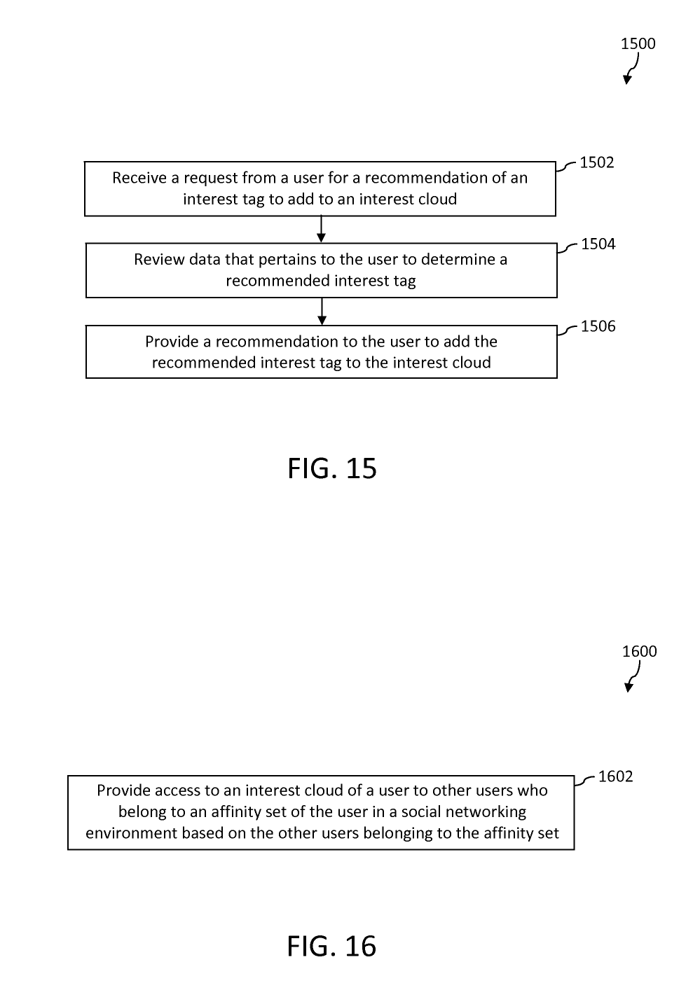

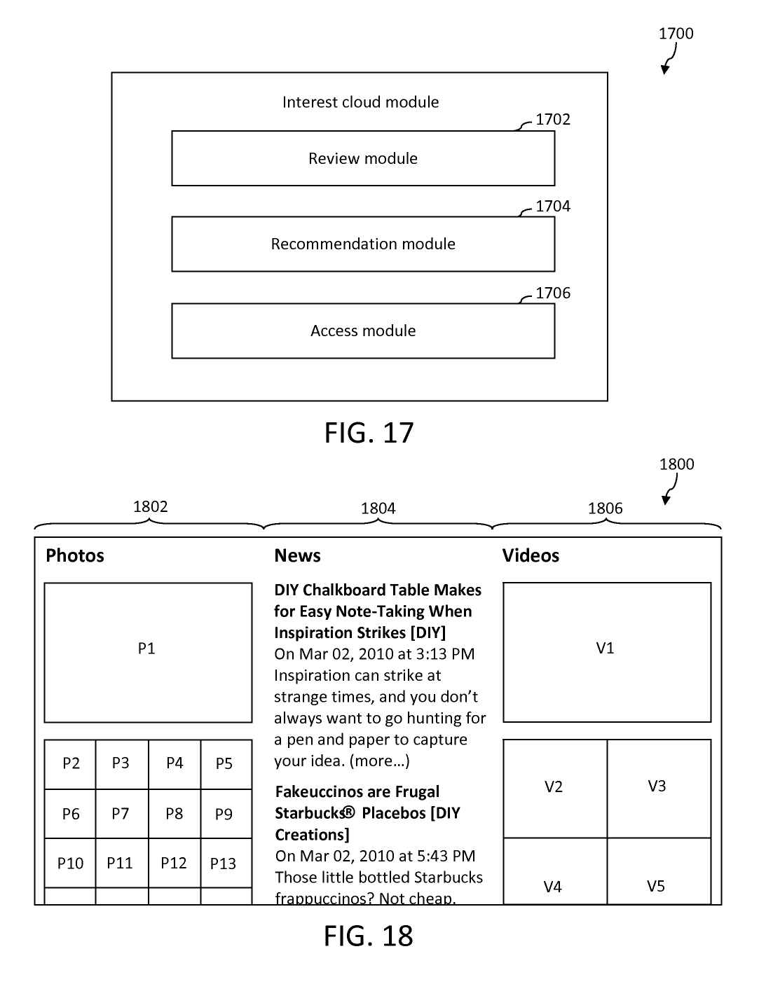

FIG. 15 depicts a flowchart 1500 of an example method of recommending an interest tag to a user in accordance with an embodiment described herein. FIG. 16 depicts a flowchart 1600 of an example method of providing access to an interest cloud in accordance with an embodiment described herein. Flowcharts 1500 and 1600 may be performed by interest cloud module 108 of computer system 100 shown in FIG. 1, for example. For illustrative purposes, flowcharts 1500 and 1600 are described with respect to an interest cloud module 1700 shown in FIG. 17, which is an example of an interest cloud module 108, according to an embodiment. As shown in FIG. 17, interest cloud module 1700 includes a review module 1702, a recommendation module 1704, and an access module 1706. Further structural and operational embodiments will be apparent to persons skilled in the relevant art(s) based on the discussion regarding flowcharts 1500 and 1600.

As shown in FIG. 15, the method of flowchart 1500 begins at step 1502. In step 1502, a request is received from a user for a recommendation of an interest tag to add to an interest cloud. In an example implementation, review module 1702 receives the request from the user. In some example embodiments, step 1502 need not necessarily be performed.

At step 1504, data that pertains to the user is reviewed to determine a recommended interest tag. In an example implementation, review module 1702 reviews the data that pertains to the user to determine the recommended interest tag.

At step 1506, a recommendation is provided to the user to add the recommended interest tag to the interest cloud. In an example implementation, recommendation module 1704 provides the recommendation to the user.

As shown in FIG. 16, the method of flowchart 1600 includes step 1602, in which access to an interest cloud of a user is provided to other users who belong to an affinity set of the user in a social networking environment based on the other users belonging to the affinity set. Such other users are often referred to as “connections” of the user. For example, an affinity set may be any group of persons, including a group of friends, business associates, players of a massively multiplayer online game, persons with a common interest, all users of a social network, application (“app”), or web site, or a subgroup thereof A user may belong to any number of affinity sets. In an example implementation, access module 1706 provides access to the interest cloud to the other users who belong to the affinity set of the user.

It will be recognized that interest cloud module 1700 may not include one or more of review module 1702, recommendation module 1704, and/or access module 1706. Furthermore, interest cloud module 1700 may include modules in addition to or in lieu of review module 1702, recommendation module 1704, and/or access module 1706.

FIG. 18 shows example content 1800 that may be provided to a user in accordance with an embodiment described herein. As shown in FIG. 18, content 1800 includes three types of content: image content 1802, news content 1804, and video content 1806. Interest tags that are associated with image content may be taken into consideration for selecting image content 1802; interest tags that are associated with news content may be taken into consideration for selecting news content 1804; and interest tags that are associated with video content may be taken into consideration for selecting video content 1806.

Image content 1802 includes a plurality of images. Images P1-P13 of the plurality of images are shown in FIG. 18 for illustrative purposes. News content 1804 includes a plurality of news articles. Each article is displayed as a title and corresponding introductory text for illustrative purposes, though it will be recognized that each article may be displayed in any suitable manner. The user may select the title of an article, a graphical interface element that is associated with the article, introductory text of the article, etc. to see the entire article. Alternatively, each article in news content 1804 may be displayed as an entire article. Video content 1806 includes a plurality of videos. Videos V1-V5 of the plurality of videos are shown in FIG. 18 for illustrative purposes.

Images in addition to images P1-P13, news articles in addition to those shown in FIG. 18, and/or videos in addition to videos V1-V5 may be viewed by using a scrolling element that is associated with content 1800 or clicking a graphical interface element, such as a “next” button.

Image content 1802, news content 1804, and video content 1806 are provided in respective columns in FIG. 18 for illustrative purposes and are not intended to be limiting. Different types of content may be provided in any suitable configuration.

### III. Other Example Embodiments

It should be noted that interest cloud module 108 of FIG. 1 may include interest determination module 1002, cloud provider 1004, content selector 1006, proximity module 1008, priority module 1010, association module 1012, content provider 1014, and/or recommendation module 1016 of FIG. 10; review module 1702, recommendation module 1704, and/or access module 1706 of FIG. 17; or any portion or combination thereof, for example, though the scope of the embodiments is not limited in this respect.

Interest cloud module 108, module 1002, cloud provider 1004, content selector 1006, proximity module 1008, priority module 1010, association module 1012, content provider 1014, recommendation module 1016 review module 1702, recommendation module 1704, and access module 1706 may be implemented in hardware, software, firmware, or any combination thereof For example, interest cloud module 108, module 1002, cloud provider 1004, content selector 1006, proximity module 1008, priority module 1010, association module 1012, content provider 1014, recommendation module 1016 review module 1702, recommendation module 1704, and/or access module 1706 may be implemented as computer program code configured to be executed in one or more processors. In another example, interest cloud module 108, module 1002, cloud provider 1004, content selector 1006, proximity module 1008, priority module 1010, association module 1012, content provider 1014, recommendation module 1016 review module 1702, recommendation module 1704, and/or access module 1706 may be implemented as hardware logic/electrical circuitry.

### IV. Example Computer Implementation

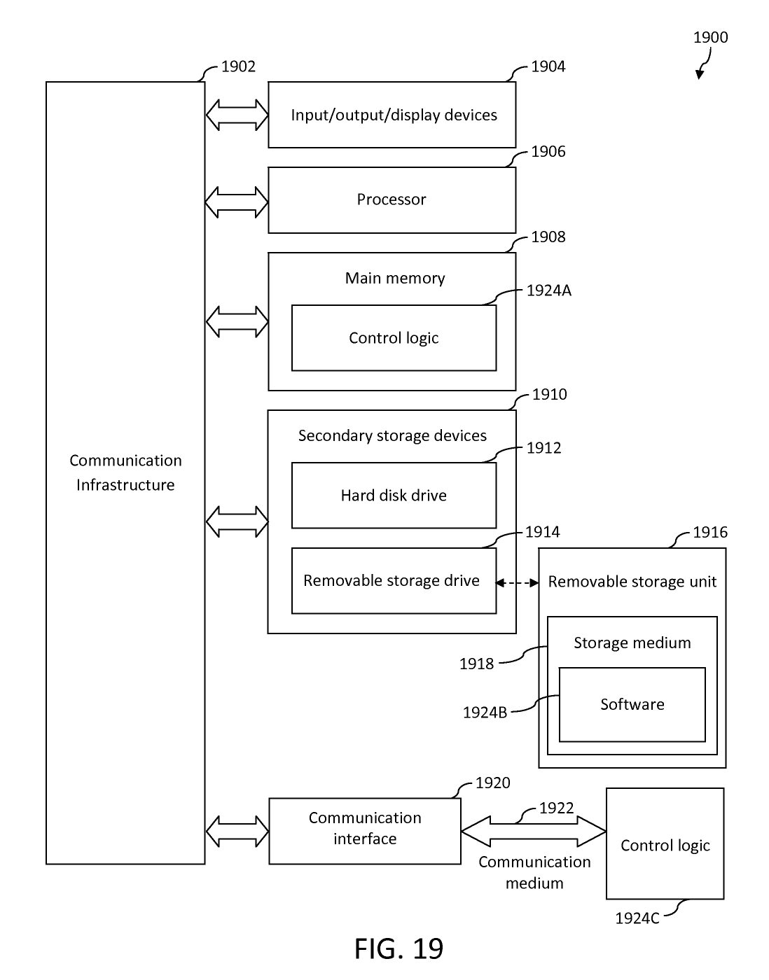

The embodiments described herein, including systems, methods/processes, and/or apparatuses, may be implemented using well known servers/computers, such as computer 1900 shown in FIG. 19. For example, elements of example computer system 100, including any of the user systems 102A-102M and any of the servers 106A-106N depicted in FIG. 1 and elements thereof (including interest cloud module 108 depicted in FIGS. 1, 10, and 17 and elements thereof), and each of the steps of flowcharts 200, 400, 500, 600, 700, 800, 900, 1400, 1500, and 1600 depicted in respective FIGS. 2, 4-9, and 14-16 can each be implemented using one or more computers 1900.

Computer 1900 can be any commercially available and well known computer capable of performing the functions described herein, such as computers available from International Business Machines, Apple, Sun, HP, Dell, Cray, etc. Computer 1900 may be any type of computer, including a desktop computer, a server, etc.

As shown in FIG. 19, computer 1900 includes one or more processors (e.g., central processing units (CPUs)), such as processor 1906. Processor 1906 may include interest cloud module 108 of FIG. 1; interest determination module 1002, cloud provider 1004, content selector 1006, proximity module 1008, priority module 1010, association module 1012, content provider 1014, and/or recommendation module 1016 of FIG. 10; review module 1702, recommendation module 1704, and/or access module 1706 of FIG. 17; or any portion or combination thereof, for example, though the scope of the embodiments is not limited in this respect. Processor 1906 is connected to a communication infrastructure 1902, such as a communication bus. In some embodiments, processor 1906 can simultaneously operate multiple computing threads.

Computer 1900 also includes a primary or main memory 1908, such as a random access memory (RAM). Main memory has stored therein control logic 1924A (computer software), and data.

Computer 1900 also includes one or more secondary storage devices 1910. Secondary storage devices 1910 include, for example, a hard disk drive 1912 and/or a removable storage device or drive 1914, as well as other types of storage devices, such as memory cards and memory sticks. For instance, computer 1900 may include an industry standard interface, such as a universal serial bus (USB) interface for interfacing with devices such as a memory stick. Removable storage drive 1914 represents a floppy disk drive, a magnetic tape drive, a compact disk drive, an optical storage device, tape backup, etc.

Removable storage drive 1914 interacts with a removable storage unit 1916. Removable storage unit 1916 includes a computer useable or readable storage medium 1918 having stored therein computer software 1924B (control logic) and/or data. Removable storage unit 1916 represents a floppy disk, magnetic tape, compact disc (CD), digital versatile disc (DVD), Blue-ray disc, optical storage disk, memory stick, memory card, or any other computer data storage device. Removable storage drive 1914 reads from and/or writes to removable storage unit 1916 in a well known manner.

Computer 1900 also includes input/output/display devices 1904, such as monitors, keyboards, pointing devices, etc.

Computer 1900 further includes a communication or network interface 1920. Communication interface 1920 enables computer 1900 to communicate with remote devices. For example, communication interface 1920 allows computer 1900 to communicate over communication networks or mediums 1922 (representing a form of a computer useable or readable medium), such as local area networks (LANs), wide area networks (WANs), the Internet, etc. Network interface 1920 may interface with remote sites or networks via wired or wireless connections. Examples of communication interface 1922 include but are not limited to a modem, a network interface card (e.g., an Ethernet card), a communication port, a Personal Computer Memory Card International Association (PCMCIA) card, etc.

Control logic 1924C may be transmitted to and from computer 1900 via the communication medium 1922.

Any apparatus or manufacture comprising a computer useable or readable medium having control logic (software) stored therein is referred to herein as a computer program product or program storage device. This includes, but is not limited to, computer 1900, main memory 1908, secondary storage devices 1910, and removable storage unit 1916. Such computer program products, having control logic stored therein that, when executed by one or more data processing devices, cause such data processing devices to operate as described herein, represent embodiments of the invention.

For example, each of the elements of example servers 106A-106N, including interest cloud module 108 of FIG. 1; interest determination module 1002, cloud provider 1004, content selector 1006, proximity module 1008, priority module 1010, association module 1012, content provider 1014, and recommendation module 1016, each depicted in FIG. 10; review module 1702, recommendation module 1704, and access module 1706, each depicted in FIG. 17; and each of the steps of flowcharts 200, 400, 500, 600, 700, 800, 900, 1400, 1500, and 1600 depicted in respective FIGS. 2, 4-9, and 14-16 can be implemented as control logic that may be stored on a computer useable medium or computer readable medium, which can be executed by one or more processors to operate as described herein.

### V. CONCLUSION

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method comprising:
determining a plurality of interests of a user;
providing an interest cloud that includes a plurality of interest tags in response to determining the plurality of interests, each interest tag of the plurality of interest tags corresponding to a respective interest of the plurality of interests; and
selecting content to be provided to the user based on the plurality of interest tags.

2. The method of claim 1, further comprising:
receiving an add indicator from the user, the add indicator specifying a designated interest tag to be added to the interest cloud, the designated interest tag corresponding to an interest of the user; and
adding the designated interest tag to the interest cloud in response to receiving the add indicator.

3. The method of claim 1, wherein the plurality of interest tags is associated with a plurality of respective priorities, the method further comprising:
receiving a priority indicator from the user, the priority indicator specifying a designated priority to be associated with a designated interest tag of the plurality of interest tags; and
changing an association of the designated interest tag from a first priority to the designated priority in response to receiving the priority indicator.

4. The method of claim 3, further comprising:
determining that a cursor is positioned proximate the designated interest tag; and
providing a priority selection element that corresponds to the designated interest tag to the user in response to determining that the cursor is positioned proximate the designated interest tag, the priority selection element enabling the user to select the designated priority to be associated with the designated interest tag;
wherein receiving the priority indicator comprises:
receiving the priority indicator in response to selection of the designated priority by the user.

5. The method of claim 1, further comprising:
receiving a first content indicator from the user, the first content indicator specifying that a first subset of the plurality of interest tags is to be associated with a first type of content;
associating the first subset of the plurality of interest tags with the first type of content in response to receiving the first content indicator;
receiving a second content indicator from the user, the second content indicator specifying that a second subset of the plurality of interest tags is to be associated with a second type of content; and
associating the second subset of the plurality of interest tags with the second type of content in response to receiving the second content indicator;
wherein selecting the content to be provided to the user comprises:
selecting first content of the first type to be provided to the user based on the first subset of the plurality of interest tags, and
selecting second content of the second type to be provided to the user based on the second subset of the plurality of interest tags.

6. The method of claim 1, further comprising:
determining that a cursor is positioned proximate a first interest tag of the plurality of interest tags; and
providing a content selection element that corresponds to the first interest tag to the user in response to determining that the cursor is positioned proximate the first interest tag, the content selection element enabling the user to select a type of content from among a plurality of types of content to be provided to the user with respect to the first interest tag.

7. The method of claim 1, wherein providing the interest cloud comprises:
providing a visual representation of each interest tag of the plurality of interest tags, each visual representation indicating a source of the respective interest tag.

8. The method of claim 1, further comprising:
providing the content to the user;
receiving a modification indicator from the user in response to providing the content to the user, the modification indicator specifying a change to be made with respect to at least one interest tag in the plurality of interest tags;
changing the at least one interest tag in the plurality of interest tags to provide an updated plurality of interest tags in response to receiving the modification indicator; and
updating the content in real-time based on the updated plurality of interest tags.

9. The method of claim 1, further comprising:
receiving a relationship indicator from the user, the relationship indicator specifying a relationship that is to be formed between a first interest tag of the plurality of interest tags and a second interest tag of the plurality of interest tags; and
adding a cumulative interest tag to the interest cloud in response to receiving the relationship indicator, the cumulative interest tag including the first interest tag and the second interest tag having the relationship that is specified by the relationship indicator.

10. The method of claim 9, further comprising:
determining that a cursor is positioned proximate the first interest tag; and
providing a recommendation element that corresponds to the first interest tag to the user in response to determining that the cursor is positioned proximate the first interest tag, the recommendation element recommending formation of the relationship between the first interest tag and the second interest tag;
wherein receiving the relationship indicator comprises:
receiving the relationship indicator in response to providing the recommendation element to the user.

11. The method of claim 9, further comprising:
setting a designated priority to be greater than a first priority of the first interest tag based on the cumulative interest tag including the first interest tag and to be greater than a second priority of the second interest tag based on the cumulative interest tag including the second interest tag; and
associating the designated priority with the cumulative interest tag.

12. The method of claim 1, further comprising:
receiving a request from the user for a recommendation of an interest tag to add to the interest cloud;
reviewing data that pertains to the user to determine a recommended interest tag; and
providing a recommendation to the user to add the recommended interest tag to the interest cloud.

13. The method of claim 1, further comprising:
providing access to the interest cloud to other users who belong to an affinity set of the user in a social networking environment based on the other users belonging to the affinity set.

14. The method of claim 1, wherein determining the plurality of interests of the user comprises:
determining the plurality of interests of the user based on a selection indicator that is received from the user, the selection indicator specifying a second plurality of interest tags that is selected by the user from a second interest cloud of another user.

15. A system comprising:
an interest module configured to determine a plurality of interests of a user;
a cloud provider configured to provide an interest cloud that includes a plurality of interest tags in response to a determination of the plurality of interests, each interest tag of the plurality of interest tags corresponding to a respective interest of the plurality of interests; and
a content selector configured to select content to be provided to the user based on the plurality of interest tags.

16. The system of claim 15, further comprising:
a cloud modifier configured to add a designated interest tag to the interest cloud in response to receipt of an add indicator from the user;
wherein the add indicator specifies that the designated interest tag is to be added to the interest cloud; and
wherein the designated interest tag corresponds to an interest of the user.

17. The system of claim 15, further comprising:
a priority module configured to change a priority that is associated with a designated interest tag of the plurality of interest tags to be a designated priority in response to receipt of a priority indicator from the user;
wherein the priority indicator specifies that the designated priority is to be associated with the designated interest tag.

18. The system of claim 17, further comprising:
a proximity module configured to determine that a cursor is positioned proximate the designated interest tag;
wherein the cloud provider is further configured to provide a priority selection element that corresponds to the designated interest tag to the user in response to the cursor being positioned proximate the designated interest tag, the priority selection element enabling the user to select the designated priority to initiate provision of the priority indicator to the priority module.

19. The system of claim 15, further comprising:
an association module configured to associate a first subset of the plurality of interest tags with a first type of content in response to receipt of a first content indicator from the user, the association module further configured to associate a second subset of the plurality of interest tags with a second type of content in response to receipt of a second content indicator from the user;
wherein the first content indicator specifies that the first subset of the plurality of interest tags is to be associated with the first type of content;
wherein the second content indicator specifies that the second subset of the plurality of interest tags is to be associated with the second type of content;
wherein the content includes first content of the first type and second content of the second type; and
wherein the content selector is configured to select the first content to be provided to the user based on the first subset of the plurality of interest tags and to select the second content to be provided to the user based on the second subset of the plurality of interest tags.

20. The system of claim 15, further comprising:
a proximity module configured to determine that a cursor is positioned proximate a first interest tag of the plurality of interest tags;
wherein the cloud provider is further configured to provide a content selection element that corresponds to the first interest tag to the user in response to the cursor being positioned proximate the first interest tag, the content selection element enabling the user to select a type of content from among a plurality of types of content to be provided to the user with respect to the first interest tag.

21. The system of claim 15, wherein the cloud provider is configured to provide a visual representation of each interest tag of the plurality of interest tags; and
wherein each visual representation indicates a source of the respective interest tag.

22. The system of claim 15, wherein the content selector is configured to update the content in real-time based on a change with respect to at least one of the plurality of interest tags.

23. The system of claim 15, further comprising:
a cloud modifier configured to add a cumulative interest tag to the interest cloud in response to receipt of a relationship indicator from the user;
wherein the relationship indicator specifies a relationship that is to be formed between a first interest tag of the plurality of interest tags and a second interest tag of the plurality of interest tags; and
wherein the cumulative interest tag includes the first interest tag and the second interest tag having the relationship that is specified by the relationship indicator.

24. The system of claim 23, further comprising:
a proximity module configured to determine that a cursor is positioned proximate the first interest tag;
wherein the cloud provider is further configured to provide a recommendation element that corresponds to the first interest tag to the user in response to the cursor being positioned proximate the first interest tag, the recommendation element recommending formation of the relationship between the first interest tag and the second interest tag, the recommendation element enabling the user to authorize the formation of the relationship to initiate provision of the relationship indicator to the cloud modifier.

25. The system of claim 23, further comprising:
a priority module configured to set a designated priority to be greater than a first priority of the first interest tag based on the cumulative interest tag including the first interest tag and to be greater than a second priority of the second interest tag based on the cumulative interest tag including the second interest tag, the priority module further configured to associate the designated priority with the cumulative interest tag.

26. The system of claim 15, further comprising:
a review module configured to review data that pertains to the user to determine a recommended interest tag in response to receipt of a request from the user for a recommendation of an interest tag to add to the interest cloud; and
a recommendation module configured to provide a recommendation to the user to add the recommended interest tag to the interest cloud.

27. The system of claim 15, further comprising:
an access module configured to provide access to the interest cloud to other users who belong to an affinity set of the user in a social networking environment based on the other users belonging to the affinity set.

28. The system of claim 15, wherein the interest module is configured to determine the plurality of interests of the user based on a selection indicator that specifies a second plurality of interest tags that is selected by the user from a second interest cloud of another user.

29. A computer program product comprising a computer-readable medium having computer program logic recorded thereon for enabling a processor-based system to select content to be provided to a user, comprising:
a first program logic module for enabling the processor-based system to determine a plurality of interests of the user;
a second program logic module for enabling the processor-based system to provide an interest cloud that includes a plurality of interest tags in response to determination of the plurality of interests, each interest tag of the plurality of interest tags corresponding to a respective interest of the plurality of interests; and
a third program logic module for enabling the processor-based system to select the content to be provided to the user based on the plurality of interest tags.
